(19) United States
(12) Patent Application Publication
(10) Pub. No.: US 2005/0030981 A1
(43) Pub. Date: Feb. 10, 2005

(54) System and method for many-to-many layer 2 aggregation for SONET paths

(75) Inventors: Wayne Robert Sankey, Plano, TX (US); Ross Alexander Jamieson, Plano, TX (US); John Kevin Weeks, Richardson, TX (US); Hamid Reza Razaie, Dallas, TX (US); Paul Anthony Elias, Richardson, TX (US); Michael Joseph Mezeul, Allen, TX (US); Nimer Ibrahim Yaseen, Allen, TX (US)

Correspondence Address: HAYNES AND BOONE, LLP, 901 MAIN STREET, SUITE 3100, DALLAS, TX, 75202, US

(73) Assignee: Covaro Networks, Inc., Richardson, TX (US)

(21) Appl. No.: 10/912,333

(22) Filed: Aug. 5, 2004

Related U.S. Application Data
(60) Provisional application No. 60/492,536, filed on Aug. 5, 2003.

(51) Int. Cl. H04L 12/28; H04L 12/56; H04J 3/02

(52) U.S. Cl. 370/539

(57) ABSTRACT

Provided are a system and method for many-to-many layer 2 aggregation for SONET paths in a communications environment. In one example, the method includes receiving the data unit from either a layer 2 mapped data port or a SONET path, and classifying the data unit based on information within the data unit to identify which one of multiple logical flows is associated with the data unit. Each of the logical flows connects a data port with a SONET path and vice versa, and the data ports and SONET paths do not have a one-to-one correspondence. The data unit is directed to an outgoing SONET path associated with the logical flow if the data unit was received from the data port and to an outgoing data port associated with the logical flow if the data unit was received from a SONET path.

### CROSS-REFERENCE

This application claims priority from U.S. Provisional Patent Application Ser. No. 60/492,536, filed on Aug. 5, 2003, and entitled SYSTEM AND METHOD FOR MANY-TO-MANY LAYER 2 AGGREGATION FOR SONET PATHS, which is hereby incorporated by reference in its entirety.

### BACKGROUND

Communications systems linking data ports with synchronous optical network (SONET) systems provide a one-to-one connection between a given data port and SONET path. All data traffic received from the data port is sent to the connected SONET path and vice versa, which limits a total number of possible connections to the larger of the number of data ports or the number of SONET paths. In addition, service providers attempting to deploy Ethernet over SONET systems often have difficulties stemming from such factors as vendors supplying different management protocols per service type, forcing service providers to learn vendor specific element managers and to integrate these devices into their operation support system (OSS).

Accordingly, what is needed is a system and method for resolving these and other issues.

### BRIEF DESCRIPTION OF THE DRAWINGS

FIG. 1 illustrates one embodiment of an exemplary system within which the present disclosure may be implemented.

FIG. 2 is a more detailed example of one embodiment of a component of FIG. 1.

FIG. 3 illustrates an exemplary flow of data through the component of FIG. 2.

FIG. 4 is a flowchart of an exemplary method for many-to-many aggregation that may be used within the system of FIG. 1.

FIG. 5 is an example of a classification process that may be used with the method of FIG. 4.

FIG. 6 is an example of a queuing process that may be used with the method of FIG. 4.

FIG. 7 is an example of a transformation process that may be used with the method of FIG. 4.

FIG. 8 illustrates the data flow of FIG. 3 in conjunction with a management mechanism.

### DETAILED DESCRIPTION

This disclosure relates generally to communications systems and, more particularly, to providing a system and method for many-to-many layer 2 aggregation for SONET paths. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

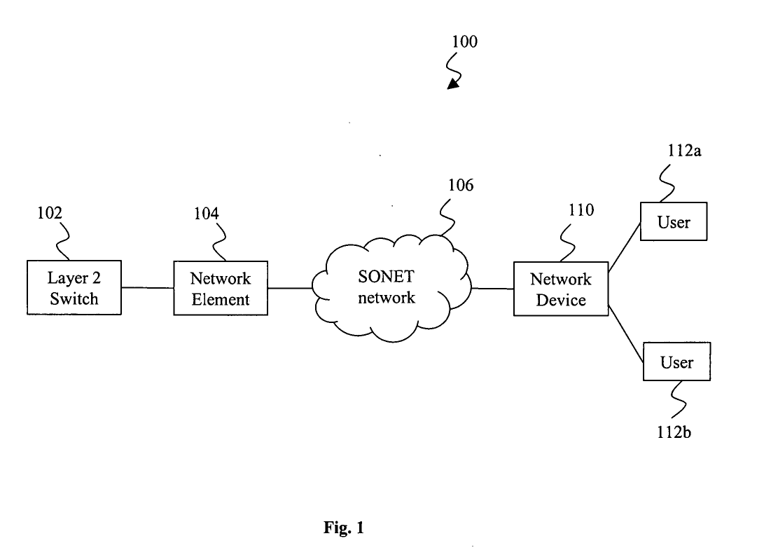

Referring to FIG. 1, one embodiment of an exemplary system 100 is illustrated. The system 100 includes a component 102 (such as a layer 2 switch) connected via a network element 104 to a synchronous optical network (SONET) 106. The component 102 communicates with the network element 104 via a technology such as Ethernet 802.3 and the network element communicates with the SONET network 106 via a technology such as Ethernet over SONET. For purposes of clarity, the term SONET is used throughout the present disclosure to refer to SONET and synchronous digital hierarchy (SDH) technologies. Accordingly, it is understood that references to SONET may be replaced with references to SDH, although some minor changes may be needed, as will be known to those of skill in the art. The SONET network is connected to multiple users 112a and 112b via a network device 110 (e.g., a destination node able to remove frames from a payload and forward the frames to the proper user 112a, 112b).

Although the network element 104 is shown as a separate component from the component 102 and SONET network 106, it is understood that the network element 104 may incorporate one or both of these components, may incorporate portions of one or both of these components, or may be incorporated into one or both of these components. Furthermore, various functions of the network element 104 may be distributed among various components in the system 100. In addition, it is understood that other networks and/or protocols may be used, such as Ethernet or token ring. Accordingly, it is understood that the system 100 illustrates one possible configuration and set of components, and that many other configurations and/or components may be used.

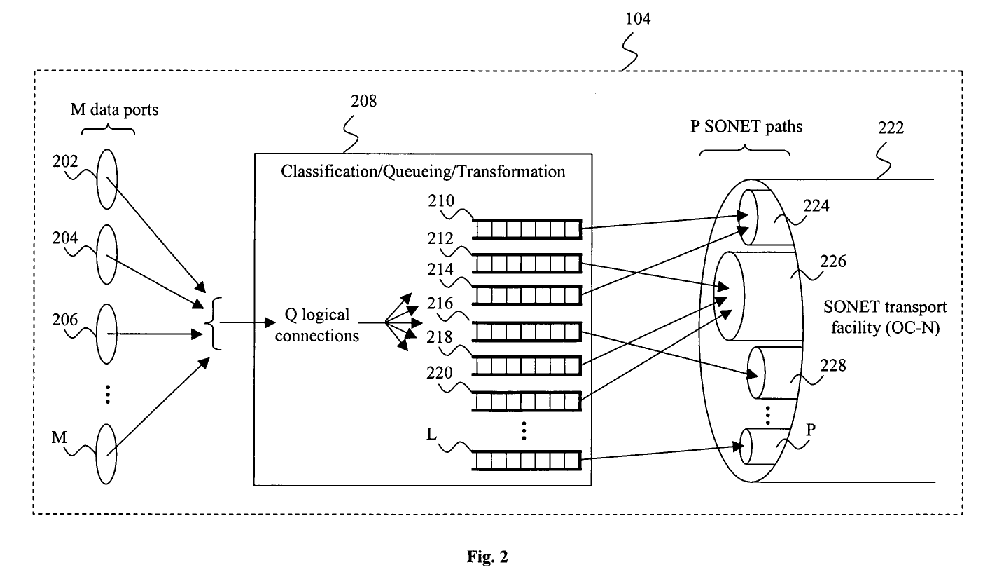

With additional reference to FIG. 2, one embodiment of the network element 104 of FIG. 1 is illustrated. The network element is connected to the layer 2 component 102 via data ports 202, 204, 206, . . . , M and to the SONET network 106 via a SONET transport facility 222 having optical carriers (OCs) defining logical link connections 224, 226, 228, . . . , P (e.g., SONET paths). The data ports are identified by a labeling scheme such as a layer 2 scheme (e.g., multiprotocol label switching (MPLS), Ethernet 802.3p/Q, media access control (MAC) addresses, resilient packet ring, or other schema designed to separate logical channel traffic flows). The SONET paths may be specified by a known standard such as Telcordia GR-253.

The network element 104 is designed to provide logical paths (e.g., logical flows) for data to flow between the data ports 202-M and SONET paths 224-P. An aggregator 208 comprising circuitry and/or executable software instructions provides for multiple logical flows Q between the data ports and the SONET paths. There may be up to Q×M×P flows, and each flow may be unidirectional or bidirectional, single-cast or multicast, and connection oriented or not connection oriented.

The system 100 may be configured to provide different types or modes of data flows. For example, in one embodiment, all traffic on a data port may belong to one flow (e.g., “port mapped”). In the port-mapped mode, the system 100 maps all ingress subscriber frames arriving on a data port to the same SONET path. For example, the SONET path may include one of more synchronous transport signal (e.g., STS-1) payloads operating in either contiguous concatenation or virtual concatenation mode. The mapping relationship is between the ingress data port and the SONET path. All ingress frames arriving on the data port are mapped to the same SONET path regardless of their content, VLAN tags, frame type, etc., so there is only one mapping relationship associated with the data port. The STS payload carrying the flow is cross-connected through the SONET network to a destined path termination (e.g., the network device 110 of FIG. 1). At the destination node, the egress frames are removed from the STS payload and forwarded to the destination Ethernet port associated with a subscriber. All egress frames in the STS payload which belong to the subscriber in question are mapped to single port associated with the subscriber regardless of their content, frame type, VLAN tags, etc.

In another embodiment, a data port may carry traffic that is to be classified into more than one flow (e.g., “flow mapped”). In the flow-mapped mode, the system 100 classifies ingress frames arriving on the data port into various levels of granularity (depending on predefined instructions). The concept of flow was introduced to help manage the VLAN-to-SONET path mapping relationships on a port. A flow may be defined on a per port basis as a set (or subset) of uniquely identifiable groups of frames resulting from the application of a VLAN classification scheme on all frames arriving on the data port. Depending on the classification mechanism, there may be multiple VLANs and flows defined on a data port. A flow is uniquely identified with a Flow Identifier (FID). A FID may contain one or more VLANs, but a VLAN on a port can only be associated with one FID for that port. A FID is used to map the frame onto a particular SONET path associated with the FID. The SONET path may include one or more STS-1 payloads operating in either contiguously concatenated or virtually concatenated mode. The mapping relationship, in contrast to port-mapped mode, is between FID(s) (comprised of VLAN(s)) and SONET path(s) in flow-mapped mode. Note that there may be multiple relationships on the port which map flows to more than one SONET path. Ingress frames may be classified according to a number of mechanisms, but the goal of classification is to assign an ingress frame to a particular VLAN, which, in turn, associates the frame with a particular FID.

In still another embodiment, all traffic in a SONET path may belong to one flow (e.g., “private transport”). In private transport mode, the system 100 maps subscriber ingress frames from an identified traffic flow to a dedicated, private network channel on an uplink facility. The network channel may include one or more STS-1 payloads operating in either standard or virtually concatenated mode. Only frames from the provisioned subscriber ports or sub-port (flows) travel on the dedicated network channel. Data from other subscriber ports and/or flows is not allowed on the same network channel. The private transport channel can carry data from a port-mapped service or from a flow-mapped service.

In yet another embodiment, a single SONET path may carry traffic belonging to more than one flow (e.g., “shared transport”). In shared transport mode, the system 100 can map multiple subscriber traffic flows or port-mapped services to the same uplink network channel. The network channel consists of one of more STS-1 payloads operating in either standard or virtually concatenated mode. The benefit of shared transport mode is to unlock stranded bandwidth from private transport mode services.

As will be described in greater detail below, the aggregator 208 may perform such functions as classification, queuing, and transformation (assuming each of these is needed). The aggregator 208 may, in some embodiments, include multiple queues 210, 212, 214, 216, 218, 220, . . . , and L in a queuing system. The queuing system and the data ports are generally orthogonal spaces. There is a mapping function (called “classification”) that determines how the traffic from the data ports is routed to the individual queues. Each queue is associated with one of the SONET paths 224-P, and multiple queues may be associated with a single path. The association of a queue with a path may be created, modified, or deleted using a management mechanism.

In the present embodiment, the queue system includes 2048 “segments” of 64 kilobytes each. When a queue is formed, the number of the segments to be used is calculated by the network entity 104, and software then instructs the hardware as to which segments belong to which queue. After the queue is set up, the hardware then operates it autonomously as traffic is enqueued and dequeued. Accordingly, the queues can be of variable size.

It is understood that, in some embodiments, queues may not be needed. For example, if the bandwidth available for the SONET paths is greater than the bandwidth available for the data ports, and the frames are flowing from the data ports to the SONET paths, then no queues may be needed since the SONET paths can carry more data than the data ports can provide. The present example of FIG. 2 illustrates queues sending data to the SONET transport facility 222, but it is understood that additional queues (not shown) may be used to queue data flowing from the SONET transport facility 222 to the data ports.

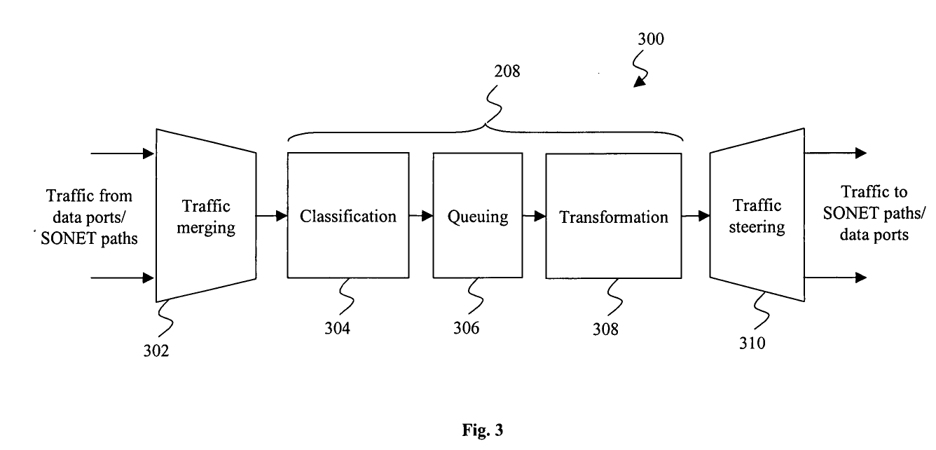

Referring now to FIG. 3, one embodiment of a data flow 300 through the network element 104 of FIGS. 1 and 2 is illustrated. For purposes of clarity, the previous example will be continued with data flowing from the data ports 202-M to the SONET transport facility 222. However, it is understood that this flow may be reversed, and that data flowing from the SONET transport facility 222 to the ports 202-M may undergo identical or similar processes. Traffic merging occurs in step 302. The traffic undergoes classification, queuing, and transformation in steps 304, 306, and 308. In step 310, traffic steering directs the traffic to the proper SONET path.

The classification of step 304 may identify the flow to which each individual data unit (e.g., frame or packet) belongs, thereby allowing separation of the frames received on one physical port into their respective flows. As will be described later in greater detail, the classification step is performed by examining one or more fields of the frame including, but not limited to, MPLS labels, IEEE 802.3p/Q tags, MAC addresses, IP addresses, and IP TOS fields. The buffering or queuing step 306 allows traffic from more than one source to be merged to one destination. For example, frames that are identified as belonging to an individual flow are written into a queue that is allocated and dedicated to that one flow. In alternative embodiments, frames from multiple flows may be designated for a single queue. The transformation step 308 may be used to modify frames as they pass through the network element 104 (if such modification is needed). For example, the transformations may include tag stacking, tag modification, tag removal, cyclic redundancy check (CRC) recalculations, etc.

In some embodiments, a scheduling step (not shown) may be used to determine the ordering and time alignment in which frames from different queues are placed into each outgoing SONET path or data port. One such scheduling method is disclosed in U.S. patent application Ser. No. 10/856,531, filed on May 28, 2004, and entitled “SYSTEM AND METHOD FOR TIME-BASED SCHEDULING,” which is hereby incorporated by reference in its entirety.

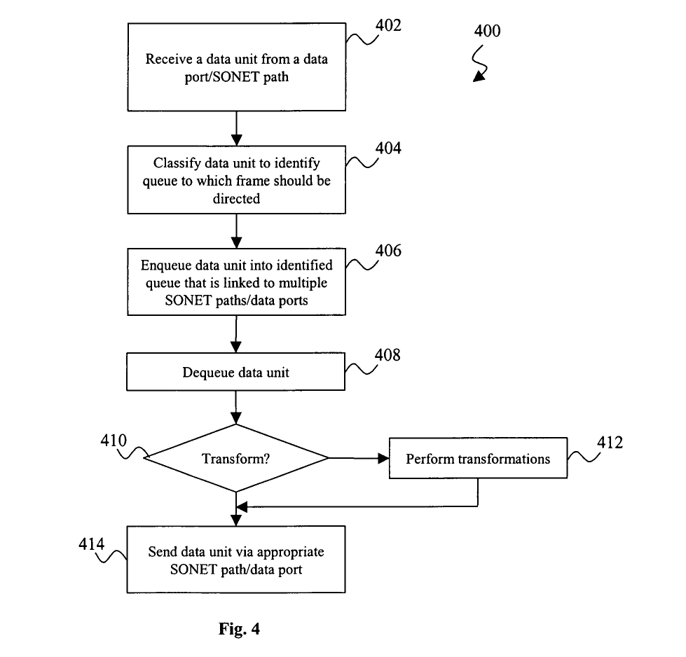

Referring to FIG. 4 and with continued reference to FIG. 2, an exemplary method 400 provides for traffic aggregation between a multiple data ports (e.g., the data ports 202-M) to one or more SONET paths (e.g., the paths 224-P) and vice versa. The present method includes the ability to place frames from any queue into any SONET path. This ability, coupled with separation of frames from different flows into different queues, may enable the network element 104 to direct traffic from any input data port to any output SONET path on ingress and vice versa on egress.

In step 402, a data unit (e.g., a frame) is received from a data port or a SONET path. For purposes of clarity, the present example focuses on receiving a frame from the data port 202 and transferring it to an appropriate SONET path (e.g., the path 224), but it is understood that the method applies equally to a frame being transferred from a SONET path to a data port.

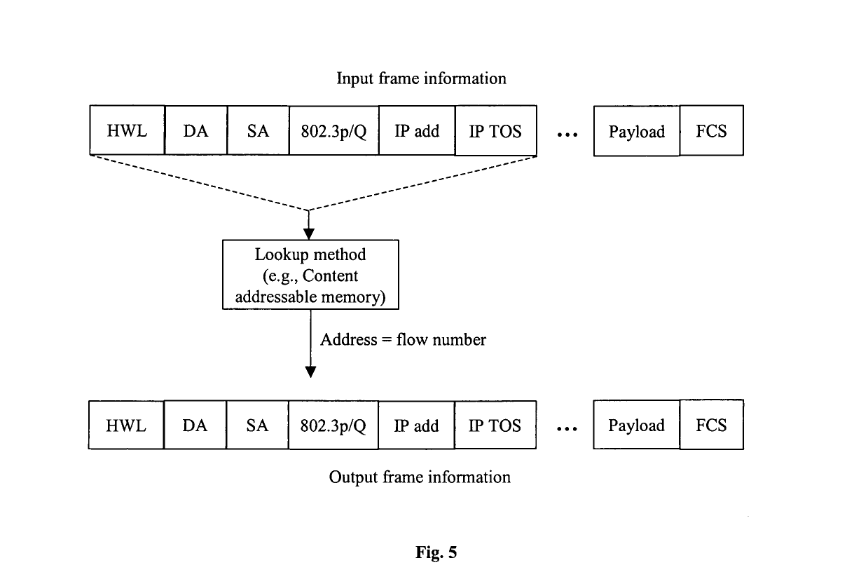

In step 404 and with additional reference to FIG. 5, the frame is classified to identify a queue (e.g., the queue 210) into which the frame is to be placed. As illustrated in FIG. 5, the frame of the present example is an Ethernet frame having commonly known fields such as a destination address (DA), source address (SA), 802.3p/Q (VLAN tag), IP address, IP type of service (TOS), payload, and frame check sequence (FCS). The classification may be based on a hardware label (HWL) that is prepended to the frame by processing circuitry, or it may be based on other attributes of the frame, such as an MPLS label, IEEE 802.3p/Q tags, MAC addresses, IP addresses, IP TOS field, etc.

In the present example, the classification process uses a lookup method based on content addressable memory (CAM), although other methods may be used. Using the information in the frame and the CAM, a flow identifier (FID) (e.g., a flow number) for the flow to which the frame belongs is identified and written into the HWL or another field for use by later circuitry.

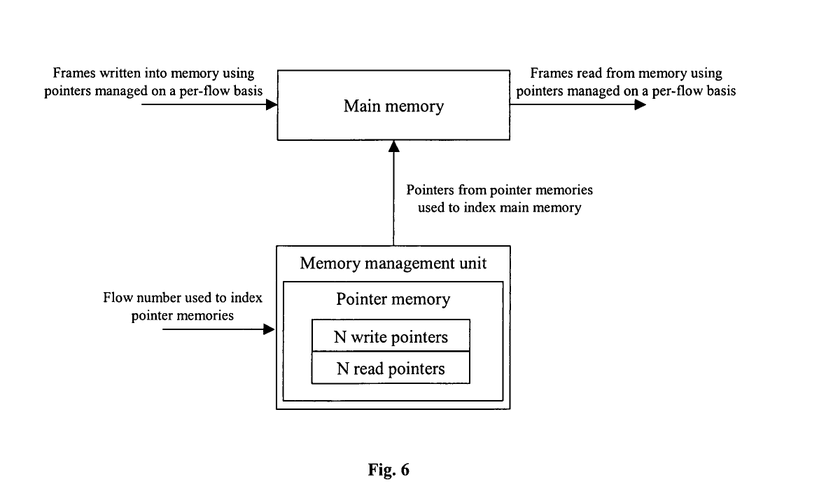

In step 406 and with additional reference to FIG. 6, the frame is handled by a queuing system. In the present example, the frame is written into main memory using one or more pointers that are managed on a per flow basis, where each flow number is used to index pointer memories contained in a memory management unit. The pointers are used in turn to index the main memory. The frame may then be read from the main memory using one or more pointers managed on a per flow basis. The frame is dequeued in step 408.

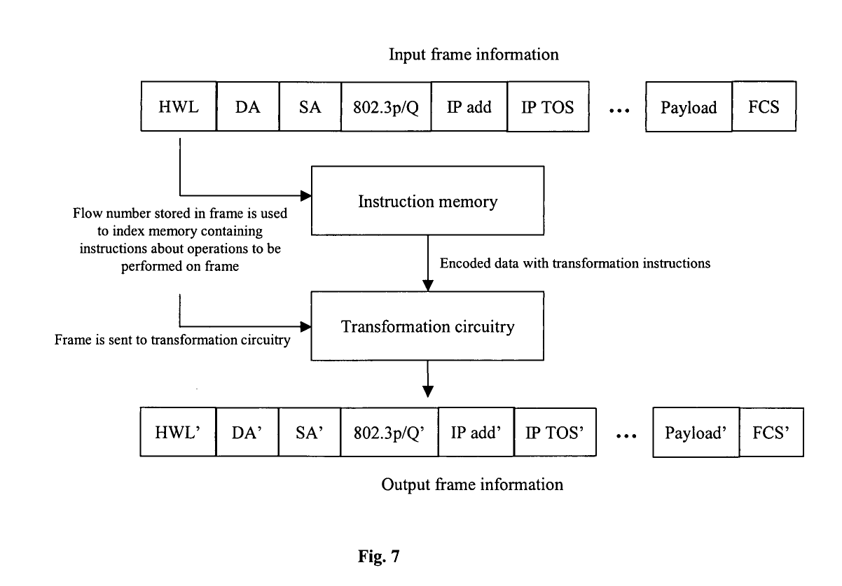

In steps 410 and 412, and with additional reference to FIG. 7, any needed transformations are performed. In the present example, the flow number associated with the frame (stored, for example, in the HWL) is used to index a memory containing instructions about operations (transformations) to be performed on the frame. As described previously, such transformations may include tag stacking, tag modification, tag removal, CRC recalculations, etc. The frame is sent into transformation circuitry, which uses the instructions to perform the transformations. The resulting frame may or may not be identical to the original frame prior to the transformation process. After the transformations are performed, or if no transformations are needed, the method 400 continues to step 414 where the frame is sent via the SONET path 224 associated with the queue 210.

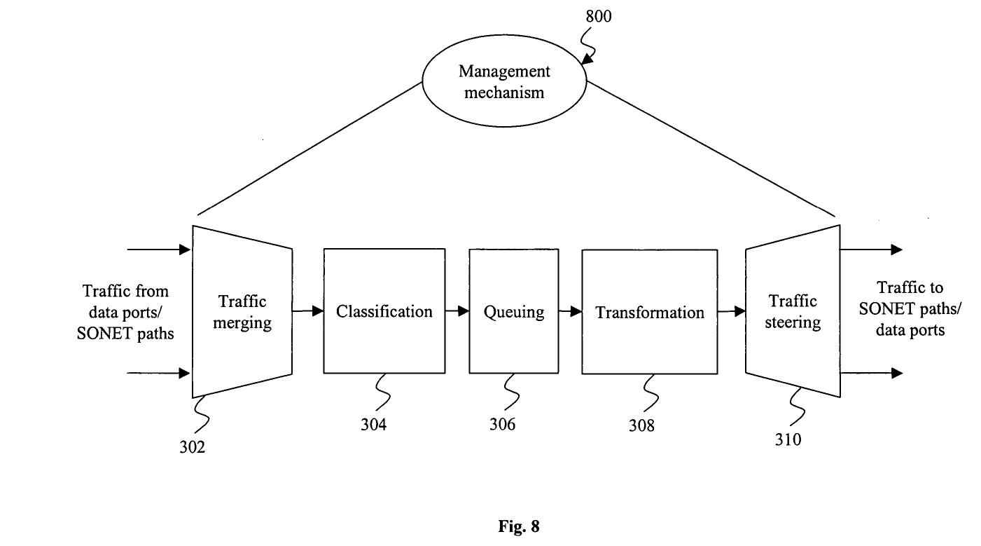

Referring now to FIG. 8, in another embodiment, a management mechanism 800 may be used to create, edit, and/or delete logical flows. In the present example, the management mechanism is implemented using Transaction Language 1 (TL-1) or the Simple Network Management Protocol (SNMP), but other technologies may be used.

In general, service providers have problems in deploying Ethernet over SONET systems in terms of efficiency and manageability. The lack of efficiency may rise from such factors as the fact that most equipment vendors do not provide flow mapped and protected cross card aggregation services. The flow mapped service provides multi-site (Internet, Intranet, etc.) connectivity and provides savings by minimizing the number of WAN links (ports) and equipment (Ethernet switches) that an end-user/customer needs to purchase. The multi-card aggregation allows the service provider to transport different customers' traffic destined to the same end point to share a common STS channel(s), rather than providing a separate STS channel(s) for each customer. Furthermore, vendors may supply different management protocols per service type, forcing service providers to learn vendor specific element managers and to integrate these devices into their OSS.

In the present embodiment, the management mechanism 800 may be used for managing an Ethernet over SONET service by creating and provisioning several types of Ethernet facilities, and provisioning private and shared STS channels using TL1 commands. For example, the present example includes provisioning port mapped ad flow mapped services.

To provision the port mapped service, an Ethernet facility (FAC) may be created on a service card (e.g., an E10/100 Ethernet service card) by entering the following TL1 command: “ENT-E100: [<TID>]:<AID>: <CTAG>::: [MODE=TLS],,,,, [,SPEED=<speed>][,CIR=<cir>][,PIR=<pir>][,BUFFERSIZE=<buffersize>][,PAUSE=<pa use>]:{<primarystate>];”. The command is similar to the command used to provision a TDM FAC (e.g., DS3) with minor modifications. Keywords are added to specify the traffic engineering specifications and port type (port-mapped or flow-mapped).

An STS cross-connect (CRS) may be created to provide a service by mapping the above FAC to an STS channel by issuing the following TL1 command: “ENT-CRS-STS1: [<TID>]:<FROM-AID>, <TO-AID>:<CTAG>:::: [<CCT>]:[TXMODE=<transportmode>][,STSMAP=<stsmap>][,VC=<virtualConcatenation>][,RSRV=<reserv eBandwidth>][,TVID=<transportVLANId>][,TXTAGCTL=<transportTagControl>];”. The command creates a private STS-1 (STS-3c/12c/48c/nv) cross connect between the FROM-AID and TO-AID. This command is similar to the command used to connect a TDM FAC to an STS channel. Furthermore, the command does not require the creation of an explicit STS, but creates it implicitly in the same manner as TDM.

To provision a flow-mapped service, an Ethernet port may be created on the Ethernet service card by entering the following TL1 command: “E100:[<TID>]:<AID>:<CTAG>::: [MODE=TLS][,AFP=<acceptable framePolicy][,EGRESS=<EgressMode>][,PVID=<portVLANId>][,PRIOVID=<priovid>][,PRIOMAPMODE=<priomapmode>][,SPEED=<speed>][,CIR=<cir>][,PIR=<pir>][,BUFFERSIZE=<buffersize>][,PAUSE=<pause>]:{<primarystate>];”. The command is like the command used to provision a TDM FAC (e.g., DS3) with minor modifications. Keywords are added to specify the traffic engineering specifications and port type (port-mapped or flow-mapped).

To create a FID associated with above FAC, the following TL1 command may be used: “ENT-FID: [<tid>]:<aid>:<ctag>:::[VLANMEMBER=<vlanMember>][,CIR=<cir>][,PIR=<pir>][,BUFFERSIZE=<buffersize>][,DUALCOS=<dualClassOfService>][,ELAT=<egressLatency>][,EELP=<egressLowLatencyPriority>]:<primaryState”. This command was introduced to look like the other commands used to create a data or TDM FAC, but has different semantics.

To create a shared STS-1 (STS-3c/12c/48c/nv), the following TL1 command may be used: “ENT-STS1NV: [<tid>]: [<aid>]:<ctag>::: [STSMAP=<stsmap>,]TXMODE=<transportMode>[,SUBSCR=<overSubscrRatio>][,MAXUNRES=<maxUnresBandwidth>],MEMBERS=<members>:[<primaryState>];”. This command is not explicitly required in private STS channel or TDM service mapping because it is implicitly created. However, in a shared service, it is required to be issued or a private STS channel is created by default.

To create an STS CRS that provides a service by mapping the above FID to the explicitly created STS channel above, the following TL1 command may be used: “ENT-CRS-STS1: [<tid>]: <fromAid>,<toAid>: <ctag>:: [<crossConnectType>]:TXMODE=<transportMode>[,STSMAP=<stsMap>][,VC=<virtualConcatenation>[,RSRV=<reserveBandwidth>][,TVID=<transportVLANId>][,TXTAGCTL=<transport-TagControl>];”. This command creates a service by connecting the FID to the STS channel, which is similar to the CRS connect command used for port mapped or TDM FAC.

Accordingly, the management mechanism 800 may be used for the provisioning of both port mapped and flow mapped services by issuing a sequence of TL1 commands which are similar in syntax to the TL1 commands used to create a TDM service in most SONET equipment.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Furthermore, various changes may be made to the methods and/or the scheduler to conform to various networks and/or protocols. Therefore, the claims should be interpreted in a broad manner, consistent with the present disclosure.

1. A method for directing a frame from one of a plurality of layer 2 mapped data ports to one of a plurality of SONET paths, wherein the data ports and SONET paths do not have a one-to-one correspondence, the method comprising:
receiving a frame from one of the data ports;
classifying the frame based on information within the frame to identify a logical flow to which the frame belongs, wherein the logical flow connects the data port from which the frame is received and a predefined one of the SONET paths; and
directing the frame to the identified SONET path.

2. The method of claim 1 wherein identifying the logical flow includes examining at least one field of the frame.

3. The method of claim 1 wherein classifying the frame includes modifying a portion of the frame to include a flow identifier that identifies the logical flow to which the frame belongs.

4. The method of claim 3 further comprising associating a hardware label with the frame, wherein modifying a portion of the frame includes storing the frame identifier in the hardware label.

5. The method of claim 1 wherein classifying the frame includes using a lookup process to identify the logical flow.

6. The method of claim 5 wherein the lookup process comprises a content addressable memory process.

7. The method of claim 1 further comprising enqueueing the frame in one of a plurality of queues that is associated with the identified SONET path.

8. The method of claim 7 further comprising enqueueing a plurality of frames from at least one other logical flow in the queue.

9. A method for associating a discrete data unit with one of a plurality of logical flows formed between a plurality of layer 2 mapped data ports and a plurality of SONET paths, wherein each logical flow connects a data port with a SONET path, and wherein the data ports and SONET paths do not have a one-to-one correspondence, the method comprising:
receiving the data unit from either a data port or a SONET path;
classifying the data unit based on information within the data unit, wherein the classification identifies which one of the logical flows is associated with the data unit; and
directing the data unit to an outgoing SONET path associated with the logical flow if the data unit was received from the data port and directing the data unit to an outgoing data port associated with the logical flow if the data unit was received from a SONET path.

10. The method of claim 9 further comprising placing the data unit into a queue associated with the outgoing SONET path or data port.

11. The system of claim 10 further comprising directing a plurality of data units from multiple queues to the outgoing SONET path or data port.

12. The method of claim 9 wherein classifying the data unit includes accessing a memory to identify the logical flow associated with the data unit.

13. The method of claim 12 further comprising comparing the information within the data unit to information within the memory.

14. A system for aggregating a layer 2 mapped connection and a SONET transport facility, the system comprising:
a plurality of layer 2 mapped data ports;
a plurality of SONET paths, wherein the SONET paths and the data ports do not have a one-to-one correspondence;
a first plurality of logical flows connecting at least one data port with multiple SONET paths and a second plurality of logical flows connecting at least one SONET path with multiple data ports; and
classification means configured to associate an incoming data unit with a particular one of the first or second logical flows based on information contained within the data unit.

15. The system of claim 14 further comprising a plurality of queues, wherein each queue is associated with a single data port or SONET path.

16. The system of claim 15 further comprising queuing means configured to direct a data unit to a particular queue based on the logical flow with which the data unit has been associated.

17. The system of claim 15 further comprising a plurality of queues associated with a single SONET path or data port, wherein a single logical flow is associated with each queue.

18. The system of claim 17 further comprising scheduling means to determine an order by which outgoing data units from different queues are directed to a SONET path or data port.

19. The system of claim 15 wherein at least a portion of the queues are of different sizes.

20. The system of claim 15 wherein the system further comprises a plurality of memory segments assignable to a queue, and wherein the number of segments for a given queue are assigned to the queue when the queue is created.

21. The system of claim 14 further comprising transformation means to change zero or more fields of the data unit.

22. The system of claim 14 wherein all traffic on at least one data port belongs to one logical flow.

23. The system of claim 14 wherein at least one data port has traffic belonging to more than one logical flow.

24. The system of claim 14 wherein all traffic on at least one SONET path belongs to a single logical flow.

25. The system of claim 14 wherein at least one SONET path has traffic belonging to more than one logical flow.

26. The system of claim 14 further comprising management means for managing an Ethernet over SONET service provided by the system.

27. The system of claim 26 wherein the management means enables a user to create and provision a plurality of Ethernet facility types on the system.

28. The system of claim 26 wherein the management means enables a user to provision private and shared STS channels using TL1 commands.

29. The system of claim 26 wherein the management means enables a user to provision port mapped and flow mapped services.

30. A method for aggregating a plurality of layer 2 mapped data ports and a plurality of SONET paths, the method comprising:
receiving first and second data units from first and second data ports, respectively;
identifying first and second logical flows to which the first and second data units belong, respectively, wherein the first logical flow connects the first data port with a first SONET path and the second logical flow connects the second data port with the first SONET path;
receiving third and fourth data units from second and third SONET paths, respectively;
identifying third and fourth logical flows to which the third and fourth data units belong, respectively, wherein the second logical flow connects the second SONET path with a third data port and the second logical flow connects the third SONET path to the third data port; and
sending the first and second data units via the first SONET path and sending the third and fourth data units via the third data port.
